(19) United States
(12) Patent Application Publication
(10) Pub. No.: US 2026/0066838 A1
(43) Pub. Date: Mar. 5, 2026

(54) DIRECTIONAL SLIDE LOCKING RAIL FOR SOLAR MODULE FRAME COUPLING

(71) Applicant: Nextracker LLC, Fremont, CA (US)

(72) Inventors: Madeleine Davis Kho, Oakland, CA (US); Ryan Patel, Pleasanton, CA (US); Ricardo Delgado-Nanez, San Jose, CA (US); Craig Bradley Edward Wildman, Kensington, CA (US)

(21) Appl. No.: 19/300,779

(22) Filed: Aug. 15, 2025

Related U.S. Application Data
(60) Provisional application No. 63/687,826, filed on Aug. 28, 2024.

(51) Int. Cl. H02S 20/32

(52) U.S. Cl. CPC H02S 20/32

(57) ABSTRACT

A system includes a solar module and a slide locking rail for coupling to the solar module frame. The solar module frame includes a locking flange. The slide locking rail includes a rail body, a first sidewall at a first side of the rail body, an alignment tab at the rail body spaced apart from the first sidewall, a first channel defined between the first sidewall and the alignment tab along the first side of the rail body, and a first hard stop extending transversely across at least a portion of the first channel. Upon relative movement between the solar module frame and the rail body, the first channel is configured to receive the locking flange of the solar module frame in contact with the first hard stop at the first channel.

### RELATED APPLICATION

This application claims the benefit of U.S. Provisional Ser. No. 63/687,826, filed Aug. 28, 2024, the entire contents of which are incorporated herein by reference.

### TECHNICAL FIELD

This disclosure relates generally to device, system, and method embodiments for coupling one or more solar module frames to a solar tracker. For examples, such embodiments disclosed herein can couple one or more solar module frames to a torque tube of a solar tracker using a slide locking rail.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor for many fastening connections to secure the rails at the torque tube and to then secure the solar modules at the installed rails. As such, the installation of solar modules at a torque tube for current solar tracking systems can add significant cost to a solar tracking system application.

### SUMMARY

This disclosure in general describes device, system, and method embodiments relating to solar module frames and solar module frame coupling apparatuses for coupling one or more solar module frames to a support structure of a solar tracker, such as a torque tube of a solar tracker. Such device, system, and method embodiments disclosed herein can be configured to facilitate more efficient and effective coupling installation of one or more solar module frames at a solar tracker support structure. For example, solar module frames and/or coupling apparatus, system, and device embodiments disclosed herein can be configured to facilitate more efficient and effective installation of one or more solar module frames at a torque tube of a solar tracker (e.g., a single-axis solar tracker) to facilitate rotation of such one or more solar module frames with the torque tube. In some such examples, solar module frame coupling device, system, and method embodiments disclosed herein can be configured to facilitate automated (e.g., autonomous, such as fully or partially robotic) installation of one or more solar module frames to a torque tube using one or more solar module frame coupling apparatus embodiments disclosed herein. In additional or alternative such examples, solar module frame coupling device, system, and method embodiments disclosed herein can be configured to reduce a number of connection points needed between tracker components to effectively couple a solar module frame to a torque tube and, thereby, can help to reduce costs associated with solar tracker installation. For instance, some such embodiments disclosed herein can facilitate locking one or more solar module frames at a slide locking rail, which itself can be secured at a torque tube, by sliding such one or more solar module frames relative to the slide locking rail to thereby cause the one or more solar module frames (e.g., a locking flange at each of the one of more solar module frames) to contact a hard stop at a channel of the slide locking rail such that when the hard stop of the frame is at (e.g., in contact with) the hard stop of the channel of the slide locking rail the frame can be fastened to the slide locking rail.

One embodiment includes a method for coupling a solar module frame to a slide locking rail. This embodiment of the method includes the steps of: placing a solar module frame relative to a first channel of a slide locking rail; imparting relative movement between the solar module frame and the first channel of the slide locking rail until a locking flange at the solar module frame is brought into contact with a hard stop at the first channel; and when the locking flange at the solar module frame is in contact with the hard stop at the first channel, fastening the slide locking rail to the solar module frame.

In a further embodiment of this method, imparting relative movement between the solar module frame and the first channel of the slide locking rail can include sliding the solar module frame along the first channel until the locking flange at the solar module frame is brought into contact with the hard stop within the first channel. The locking flange can be at a first side of the solar module frame, and the locking flange can include a first locking flange wall and a second locking flange wall, where the first locking flange wall extends up from the first side of the solar module frame and the second locking flange wall extends down from the first locking flange wall toward the first side of the solar module frame. In one such example, the locking flange can be U-shaped and extend along a portion of a length of the first side of the solar module frame at a central region along the length of the first side of the solar module frame.

In a further embodiment of this method, the hard stop at the first channel can include a tab extending transversely across the first channel at a first end of the channel. A second end of the channel, opposite the first end of the channel, can include an open channel end, and the first channel can extend along a first side of the slide locking rail between the tab at the first end of the channel and the open channel end at the second end of the channel. In one such example, imparting relative movement between the solar module frame and the first channel of the slide locking rail can include sliding the solar module frame from the open channel end, along and within the first channel, and to the hard stop to bring the locking flange at the solar module frame into contact with the tab at the first end of the channel. The second end of the channel can include a first alignment tab, and placing the solar module frame relative to the first channel of the slide locking rail can include placing the solar module frame at a first side of the alignment tab at or adjacent to the open channel end at the second end of the channel. For instance, the locking flange can be at a first longitudinal side of the solar module frame, and this first longitudinal side of the solar module frame can further include a channel alignment flange such that imparting relative movement between the solar module frame and the first channel of the slide locking rail can include first sliding the channel alignment flange past the tab and then bringing the locking flange into contact with the tab.

In a further embodiment of this method, the locking flange at the solar module frame can be fastened to the first channel at the slide locking rail to couple the solar module frame to the slide locking rail. As one example, the locking flange at the solar module frame can be fastened to the first channel at the slide locking rail by creating a clinch joint between the locking flange at the solar module frame and the first channel at the slide locking rail. As other examples, the locking flange at the solar module frame can be fastened to the first channel at the slide locking rail by inserting a blind rivet, self-piercing rivet, clamp member, or spring-biased locking finger between the locking flange at the solar module frame and the first channel at the slide locking rail.

Another embodiment includes a slide locking rail for coupling to one or more solar module frames. This slide locking rail embodiment can include a rail body; a first channel extending along a first side of the rail body from an open first channel end at a first end of the first channel to a first channel hard stop at a second, opposite end of the first channel; a second channel extending along a second side of the rail body, opposite the first side of the rail body, from an open second channel end at a first end of the second channel to a second channel hard stop at a second, opposite end of the second channel; and an alignment tab at the rail body between the first channel and the second channel. Upon relative movement between the first solar module frame and the rail body, the first channel is configured to receive a first locking flange of a first solar module frame at the first channel hard stop to couple the first solar module frame to the rail body at the first channel. And upon relative movement between the second solar module frame and the rail body, the second channel is configured to receive a second locking flange of a second solar module frame at the second channel hard stop to couple the second solar module frame to the rail body at the second channel.

In a further embodiment of this rail, the alignment tab is between the first end of the first channel and the first end of the second channel. The alignment tab can taper in width as it extends out from the rail body between the first end of the first channel and the first end of the second channel. For example, the alignment tab can be a first alignment tab, and the slide locking rail can further include a second alignment tab, where the second alignment tab is between the second channel end of the first channel and the second end of the second channel, and where the second alignment tab tapers in width as is extends out from the rail body between the second channel end of the first channel and the second channel end of the second channel.

In a further embodiment of this rail, the first channel hard stop includes a first tab that extends transversely across the first channel at the second end of the first channel, and the second channel hard stop includes a second tab extending transversely across the second channel at the second end of the second channel. In some examples, the first channel includes a first sidewall at the first side of the rail body forming a first inverted U-shape as the first sidewall extends out from the rail body, and the second channel includes a second sidewall at the second side of the rail body forming a second inverted U-shaped as the second sidewall extends out from the rail body. For instance, the first tab can extend transversely across the first inverted U-shape and terminate prior to a second alignment tab that is between the second channel end of the first channel and the second end of the second channel, and the second tab can extend transversely across the second inverted U-shape and terminate prior to the second alignment tab that is between the second channel end of the first channel and the second end of the second channel. In one such example, upon imparting sliding relative movement between the first solar module frame and the rail body, the first locking flange of the first solar module frame can be brought into contact with the first tab after the first locking flange has at least begun to slide by the alignment tab, and, upon imparting sliding relative movement between the second solar module frame and the rail body, the second locking flange of the second solar module frame can be brought into contact with the second tab after the second locking flange has at least begun to slide by the alignment tab.

An additional embodiment includes a slide locking rail solar module frame coupling system. This embodiment of the slide locking rail solar module frame coupling system includes a solar module frame and a slide locking rail. The solar module frame includes a locking flange. The slide locking rail is configured to couple to the solar module frame. The slide locking rail includes a rail body, a first sidewall at a first side of the rail body, an alignment tab at the rail body spaced apart from the first sidewall, a first channel defined between the first sidewall and the alignment tab along the first side of the rail body, with the first channel extending from a first channel open end to a second channel end, and a first hard stop extending transversely across at least a portion of the first channel at the second channel end. Upon relative movement between the solar module frame and the rail body, the first channel is configured to receive the locking flange of the solar module frame in contact with the first hard stop at the first channel.

In a further embodiment of this system, the first sidewall forms a first inverted U-shape as the first sidewall extends out from the rail body, and the first hard stop extends transversely across at least the first inverted U-shape. In one example, the locking flange can be at central region along a length of a first side of the solar module frame. The locking flange can include a first locking flange wall and a second locking flange wall. The first locking flange wall can extend up from the first side of the solar module frame, and the second locking flange wall can extend down from the first locking flange wall toward the first side of the solar module frame. The first side of the solar module frame can further include a channel alignment flange and a transition flange. The transition flange can extend between the locking flange and the channel alignment flange. The channel alignment flange can extend out from the first side of the rail a first height that can be less than a second height at which the transition flange extends out from the first side of the rail and can be less than a third height at which the locking flange extends out from the first side of the rail. The second height at which the transition flange extends out from the first side of the rail can be less than the third height at which the locking flange extends out from the first side of the rail.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a schematic, perspective view of a solar tracker apparatus.

FIGS. 2A and 2B illustrate an embodiment of a slide locking rail solar module frame coupling system. FIG. 2A is a perspective view and FIG. 2B is a cross-sectional view taken along line A-A of FIG. 2A of a pair of solar module frames coupled to an embodiment of a slide locking rail.

FIGS. 3A and 3B illustrate in isolation the embodiment of the solar module frame of FIGS. 2A-2B. FIG. 3A is a cross-sectional view (along A-A at FIG. 2A with the frame 201 in isolation) of a side of the embodiment of the solar module frame configured for coupling to the slide locking rail, and FIG. 3B is a perspective view looking at an outer surface of the side of the solar module frame.

FIGS. 4A-4C illustrate in isolation the embodiment of a slide locking rail of FIGS. 2A-2B. FIG. 4A is a perspective view of the slide locking rail, FIG. 4B is a close up of an end of the slide locking rail of FIG. 4A showing a hard stop at each of first and second channels at the slide locking rail, and FIG. 4C is an elevational view of the slide locking rail showing the same end of the slide locking rail having the pair of hard stops as in FIG. 4B.

FIG. 5 is a flow diagram of an embodiment of a method for coupling a solar module frame to a slide locking rail.

FIGS. 6A-6C illustrate an exemplary sequence for coupling at least one solar module frame to a slide locking rail, such as when executing the method of FIG. 5. FIGS. 6A and 6B illustrate an example of placing a solar module frame relative to a channel at a slide locking rail and imparting relative movement between the solar module frame and the channel of the slide locking rail. FIG. 6C illustrates an example of bringing a locking flange at the solar module frame into contact with a hard stop at the first channel, after the placing and imparting of relative movement at FIGS. 6A and 6B, such that the slide locking rail can be fastened to the solar module frame with the locking flange of the solar module frame at the hard stop.

### DETAILED DESCRIPTION

The following detailed description is exemplary in nature. The following description provides some practical illustrations for implementing examples of the present invention. Those skilled in the art will recognize that many of the noted examples have a variety of suitable alternatives.

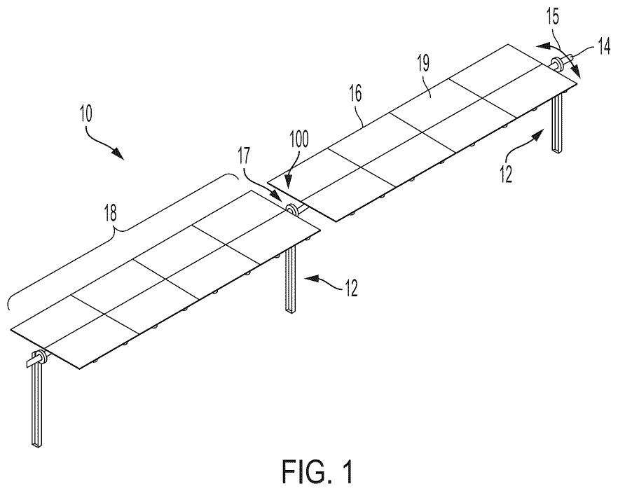

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and can be rotatably supported at each pier 12. The solar tracker apparatus 10 can further include a plurality of solar modules 16 (e.g., solar panels having photovoltaic cells 19, such as a photovoltaic laminate with a plurality of photovoltaic cells, at a frame) supported at the torque tube 14. The one or more torque tubes 14 can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 can be referred to as a bay 18 and, for example, in certain applications may be generally in the range of about 8 meters in length and each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame 100 that is coupled to the torque tube 14. As will be described herein, in some instances, the solar module frame 100 can be directly coupled to the torque tube 14 and in other instances the solar module frame 100 can be indirectly coupled to the torque tube 14 by coupling the solar module frame 100 directly to a rail component, such as a slide locking rail as described herein, and coupling that rail to the torque tube 14. As will also be described herein for various embodiments, adjacent pairs solar module frames 100 of adjacent pairs of solar modules 16 can be coupled together to the torque tube 14 (e.g., indirectly using a common rail component).

The following disclosure will describe various solar module frame coupling apparatus embodiments that can be used, for instance, at a solar tracker to couple one or more (e.g., a pair of) solar module frames to a torque tube of a solar tracker. Such embodiments disclosed herein can be useful in facilitating more labor-efficient solar module frame installation at a solar tracker apparatus by helping to reduce the number of active component connections needed during installation. For instance, embodiments disclosed herein can reduce a number of connection points, such as between a solar module frame and a rail, between a solar module frame and a torque tube, and/or between a rail and a torque tube. These embodiments can thus be useful in increasing the cost efficiency associated with installing a solar tracker system in the field as the time and labor needed can be reduced. For example, such embodiments disclosed herein can provide structures at solar module frame components and/or rail components that are conducive to robotic installation along a robotic work axis while also reducing a number of connection points.

Thus, solar module frame coupling apparatuses, and the components thereof, can be configured to facilitate more efficient and effective coupling installation of one or more solar module frames to a support structure, such as a rail at a torque tube. Namely, in such an example, solar module frame coupling apparatus embodiments disclosed herein can be configured to facilitate more efficient and effective installation of one or more solar module frames to a torque tube, such as in solar tracker applications, for instance, such as that shown at the example of FIG. 1. These solar module frame coupling apparatus embodiments will be discussed as follows in conjunction with the accompanying drawing figures.

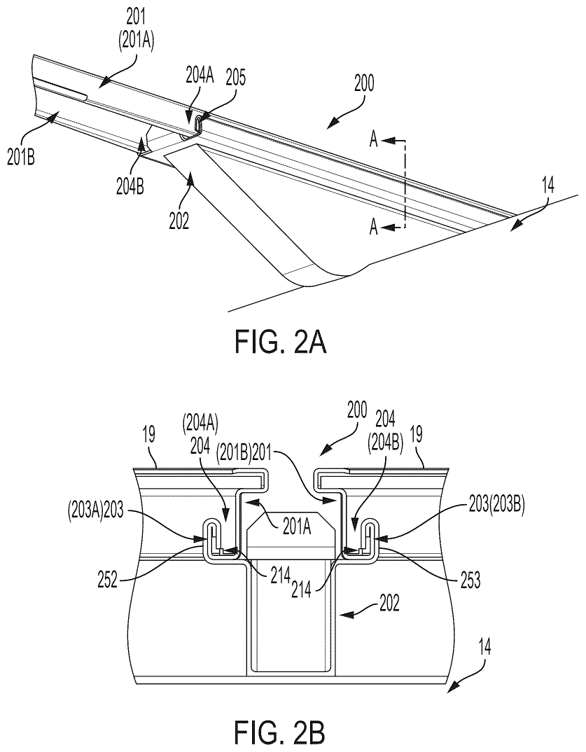

FIGS. 2A and 2B illustrate an embodiment of a slide locking rail solar module frame coupling system 200. FIG. 2A is a perspective view and FIG. 2B is a cross-sectional view of the system 200 taken along line A-A of FIG. 2A showing a pair of solar module frames 201 coupled to an embodiment of a slide locking rail 202. In particular, FIGS. 2A-2B show a first solar module frame 201A and a second solar module frame 201B each coupled to the slide locking rail 202.

The system 200 can include at least one solar module frame 201 and the slide locking rail 202. Each solar module frame 201 can include a locking flange 203, and the slide locking rail 202 can be configured to receive the locking flange 203 of one or both of the solar module frames 201A, 201B to help to couple the respective solar module frame 201A, 201B to the slide locking rail 202. More specifically, as will be disclosed further herein, for the illustrated embodiment, upon relative movement between the respective solar module frame 201A, 201B and the slide locking rail 202, the slide locking rail 202 can be configured to receive the locking flange 203 of the respective solar module frame 201A, 201B to help to couple the respective solar module frame 201A, 201B to the slide locking rail 202. Namely, for the illustrated embodiment where the slide locking rail 202 is configured to so receive and couple to a pair of solar module frames 201A, 201B, upon relative movement between each of the solar module frames 201A, 201B and the slide locking rail 202, the slide locking rail 202 can be configured to receive locking flange 203A of solar module frame 201A at a first channel 204A at the slide locking rail 202 and configured to receive locking flange 203B of solar module frame 201B at a second channel 204B at the slide locking rail 202 to help to couple the respective solar module frame 201A, 201B to the slide locking rail 202.

The slide locking rail 202 can include one or more hard stops 205, and the one or more hard stops 205 at the slide locking rail 202 can be configured to interface with the locking flange 203 of the respective solar module frame 201. Namely, for the illustrated embodiment where the slide locking rail 202 is configured to receive and couple to a pair of solar module frames 201A, 201B, the slide locking rail 202 can be configured to receive locking flange 203A of solar module frame 201A at the first channel 204A at the slide locking rail 202 and to receive locking flange 203B of solar module frame 201B at the second channel 204B at the slide locking rail 202. With the locking flanges 203A, 203B placed at the respective channels 204A, 204B, relative movement can be imparted between each of the solar module frame 201A and the slide locking rail 202 and the solar module frame 201B and the slide locking rail 202 (e.g., simultaneously or at different times) to cause the respective locking flanges 203A, 203B to be brought to interface with the hard stop 205 at each channel 204A, 204B. For instance, upon relative movement between the solar module frame 201A and the slide locking rail 202, first channel 204A at slide locking rail 202 can be configured to receive the locking flange 203A of the solar module frame 201A in contact with the first hard stop 205 at the first channel 204A. And, similarly, upon relative movement between the solar module frame 201B and the slide locking rail 202, second channel 204B at slide locking rail 202 can be configured to receive the locking flange 203B of the solar module frame 201B in contact with the first hard stop 205 at the second channel 204B. With the respective locking flange 203A, 203B brought to interface (e.g., contact) with the respective hard stop at the respective channel 204A, 204B at the slide locking rail 202, the respective solar module frame 201A, 201B can be coupled to the slide locking rail 202, such as at the respective channel 204A, 204B using a respective fastening member.

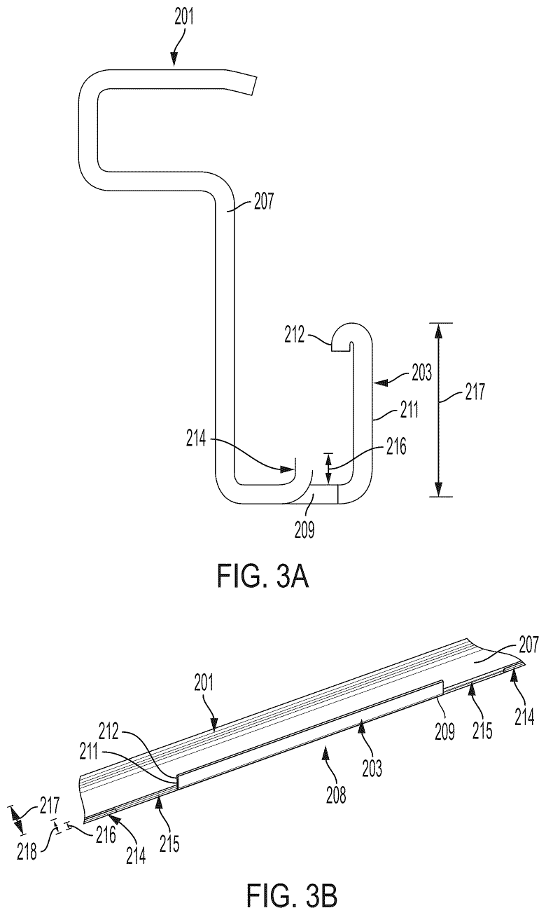

FIGS. 3A-3B illustrate in isolation the embodiment of solar module frame 201 configured for coupling to the slide locking rail 202 of the system 200. FIG. 3A is a cross-sectional view (along A-A at FIG. 2A with the frame 201 in isolation) of a side 207 (e.g., a longitudinal side) of the solar module frame 201 configured for coupling to the slide locking rail 202, and FIG. 3B is a perspective view looking at an outer surface of the side 207 of the solar module frame 201. Thus, the side 207 of the solar module frame 201 can be configured to interface with and couple to the slide locking rail 202, such as at one longitudinal side of the slide locking rail 202.

The solar module frame 201, at the side 207, can include the locking flange 203. The locking flange 203 can extend along at least a portion of a length of the side 207 of the solar module frame 201. For example, the illustrated embodiment includes the locking flange 203 extending along a portion of a length of the side 207 at a central region 208 along a length of the side 207. The locking flange 203 can include a first locking flange wall 211 and a second locking flange wall 212. The first locking flange wall 211 can extend up from a lower base surface 209 at the side 207 of the solar module frame 201, and the second locking flange wall 212 can extend down from the first locking flange wall 211 toward the lower base surface 209 at the side 207 of the solar module frame 201. For such an embodiment, the locking flange 203 can thus generally define an inverted U-shape, relative to the lower base surface 209, at a distal end of the locking flange 203.

For some embodiments, in addition to the locking flange 203, the solar module frame 201, at the side 207, can further include a channel alignment flange 214 and/or a transition flange 215. The transition flange 215 can extend along the side 207 of the solar module frame 201 between the locking flange 203 and the channel alignment flange 214. The channel alignment flange 214 can extend out from the lower base surface 209 at the side 207 of the solar module frame 201 a first height 216 that is less than a second height 218 at which the transition flange 215 extends out from the lower base surface 209 at the side 207 of the solar module frame 201 and less than a third height 217 at which the locking flange 203 extends out from the lower base surface 209 at the side 207 of the solar module frame 201. The second height 218 at which the transition flange 215 extends out from the lower base surface 219 at the side 207 of the solar module frame 201 can be less than the third height 217 at which the locking flange 203 extends out from the lower base surface 209 the side 207 of the solar module frame 201. As shown for the illustrated embodiment, the solar module frame 201 can include the locking flange 203 at a generally central region along the length of the side 207, a first channel alignment flange 214 and a first transition flange 215 can be at one side of the locking flange 203 along a length of the side 207, and a second channel alignment flange 214 and a second transition flange 215 can be at another, opposite side of the locking flange 203 along a length of the side 207. Thus, the locking flange 203 can be bounded at opposite sides by the channel alignment flanges 214 and/or a transition flanges 215.

As shown for the illustrated embodiment, the height 218 of the transition flange 215 can vary along a length of the transition flange 215. For example, the height 218 of the transition flange 215 can increase along a length of the transition flange at the side 207 moving from the channel alignment flange 214 toward the locking flange 203. This variation in the height 218 of the transition flange 215 can help to guide the side 207 of the solar module frame 201 along and relative to the rail (e.g., along and relative to a channel at the rail), for instance, when the transition flange 215 passes through a channel at the rail after the channel alignment flange 214 has passed through the channel at the rail but before the locking flange 203 has passed through this channel.

The channel alignment flange 214 can provide a type of alignment structure at the side 207 of the frame 201 help accurately place the side 207 of the frame 201 relative to the rail (e.g., relative to the desired channel at the rail). In addition, for some examples, the channel alignment flange 214, extending out the height 216 from the lower base surface 209 at the side 207, can help to provide a standoff structure between adjacent frames in a stack of solar module frames prior to installation (e.g., during shipping of the solar module frames to the installation site).

The above disclosed features have been described and illustrated at the side 207 of the solar module frame 201. Some solar module frame embodiments can include a second longitudinal side opposite the side 207 and the second longitudinal side can include one or more (e.g., each) of the features disclosed herein with respect to the side 207.

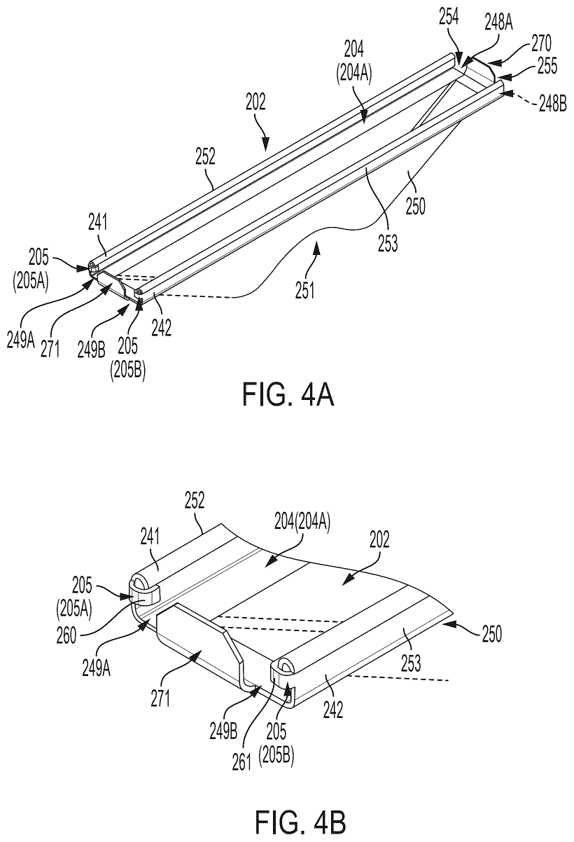

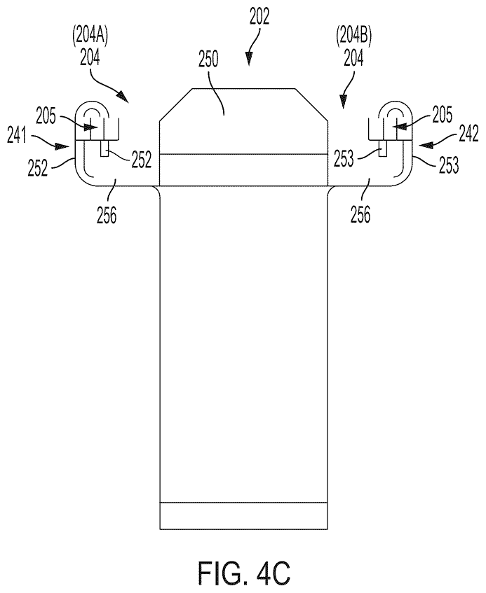

FIGS. 4A-4C illustrate in isolation the embodiment of the slide locking rail 202 of the system 200. FIG. 4A is a perspective view of the slide locking rail 202, FIG. 4B is a close up of an end of the slide locking rail 202 showing hard stops 205 at each of first and second channels 204A, 204B at the slide locking rail 202, and FIG. 4C is an elevational view of the slide locking rail 202 showing the same end of the slide locking rail having the pair of hard stops 205 as at FIG. 4B.

The slide locking rail 202 can include a rail body 250, first channel 204A, and second channel 204B. The rail body 250 can include a torque tube interface 251 which can define a cross-sectional geometry corresponding to the torque tube 14. For instance, when the torque tube 14 is generally circular in cross-sectional geometry, the torque tube interface 251 at the rail body 250 can be semi-circular in cross-sectional geometry, as shown for the illustrated embodiment, such that the rail body 250 can sit at, and couple to, the torque tube 14 at the torque tube interface 251. The first channel 204A can extend along a first side 252 of the rail body 250 from an open first channel end 254 at a first end 248A of the first channel 204A to a first channel hard stop 205A at a second, opposite end 249A of the first channel 204A. The second channel 204B can extend along a second side 253 of the rail body 250, opposite the first side 252 of the rail body 250, from an open second channel end 255 at a first end 248B of the second channel 204B to a second channel hard stop 205B at a second, opposite end 249B of the second channel 204B. For example, for certain solar tracker applications, the first channel 204A can extend along the first side 252 of the rail body 250 from the open first channel end 254 at the first end 248A of the first channel 204A to the first channel hard stop 205A at the second, opposite end 249A of the first channel 204A in an east-west orientation. And likewise, for certain solar tracker applications, the second channel 204B can extend along the second side 253 of the rail body 250 from the open second channel end 255 at the first end 248B of the second channel 204B to the second channel hard stop 205B at the second, opposite end 249B of the second channel 204B in an east-west orientation parallel to the east-west first channel 204A.

As shown for the illustrated embodiment, the first channel hard stop 205A can include a first tab 260 that extends transversely across the first channel 204A at the second end 249A of the first channel 204A, and the second channel hard stop 205B can include a second tab 261 that extends transversely across the second channel 204B at the second end 249B of the second channel 204B. The first channel 204A can include a first sidewall 241 at the first side 252 of the rail body 250. For the illustrated example, this first sidewall 241 of the first channel 204A can form a first inverted U-shape, relative to a rail body base surface 256, as the first sidewall 241 extends out from the rail body 250. Likewise, the second channel 204B can include a second sidewall 242 at the second side 253 of the rail body 250. For the illustrated example, this second sidewall 242 of the second channel 204B can form a second inverted U-shaped, relative to a rail body base surface 256, as the second sidewall 242 extends out from the rail body 250. For instance, as shown for the example here, the first tab 260 of the first channel hard stop 205A can extend transversely across the first inverted U-shape defined by the first sidewall 241 and can terminate prior to the second channel 204B (e.g., terminate prior to alignment tab 271 that is between the second channel end 249A of the first channel 204A and the second end 249B of the second channel 204B). Similarly, as also shown for the example here, the second tab 261 of the second channel hard stop 205B can extend transversely across the second inverted U-shape defined by the second sidewall 242 and can terminate prior to the first channel 204A (e.g., terminate prior to alignment tab 271 that is between the second channel end 249A of the first channel 204A and the second end 249B of the second channel 204B).

As noted, for some embodiments, the slide locking rail 202 can further include one or more alignment tabs 270 and/or 271. For example, alignment tab 270 can be located at the rail body 250, such as between the first channel 204A and the second channel 204B at the same end portion of the rail body 250 as the first and second open channel ends 254, 255.

Thus, the alignment tab 270 can be between the first end 248A of the first channel 204A and the first end 248B of the second channel 204B. For some embodiments, such as that illustrated here, the alignment tab 270 can taper in width, such as shown at FIG. 4A, as is extends out from the rail body 250 between the first end 248A of the first channel 204A and the first end 248B of the second channel 204B. For some further such embodiments, such as that illustrated here, the slide locking rail 202 can further include alignment tab 271. For example, alignment tab 271 can be located at the rail body 250, such as between the first channel 204A and the second channel 204B at the same end portion of the rail body 250 as the first and second channel hard stops 205A, 205B. Thus, the alignment tab 271 can be between the second channel end 249A of the first channel 204A and the second end 249B of the second channel 204B. The second alignment tab 271 can taper in width, such as shown at FIGS. 4A and 4B, as is extends out from the rail body 250 between the second channel end 249A of the first channel 204A and the second channel end 249B of the second channel 204B.

The alignment flanges 270 and/or 271 can be configured to help place in relative alignment the side 207 of the respective frame 201 relative to the respective channel 204A, 204B at the rail body 250. For instance, the channel alignment flange 214 at the side 207 of the frame 201 can be configured to be received between alignment flange 270 and the respective sidewall 241, 242 of the corresponding channel 204A, 204B at which the locking flange 203 is to be placed such that the alignment flange 270 can guide the channel alignment flange 214 to the respective first or second channel 204A, 204B at the respective open channel end 254, 255. In this way, as the frame 201 is imparted to move relative to the rail body 250, the alignment flange 270 can first guide the channel alignment flange 214 to the respective first or second channel 204A, 204B at the respective open channel end 254, 255, then guide the transition flange 215 to the respective first or second channel 204A, 204B at the respective open channel end 254, 255, and then guide the locking flange 203 to the respective first or second channel 204A, 204B at the respective open channel end 254, 255.

The slide locking rail 202 can be configured such that, upon relative movement between first solar module frame 201A and the rail body 250, the first channel 204A is configured to receive first locking flange 203 of first solar module frame 201A at the first channel hard stop 205A to couple the first solar module frame 201A to the rail body 250 at the first channel 204A. And, likewise, the slide locking rail 202 can be configured such that upon relative movement between the second solar module frame 201B and the rail body 250, the second channel 204B is configured to receive second locking flange 203 of second solar module frame 201B at the second channel hard stop 205B to couple the second solar module frame 201B to the rail body 250 at the second channel 204B. For instance, upon imparting sliding relative movement between the first solar module frame 201A and the rail body 250, the first locking flange 203 of the first solar module frame 201A can be brought into contact with the first tab 260 after the first locking flange 203 has at least begun to slide by the alignment tab 270. For instance, the first frame 201A can be placed initially at the first channel 204A through the first channel open end 254 and then slid along the first channel 204A at and along the rail body 250 to cause the first locking flange 203 to move from the first channel open end 254 to interface with the first channel hard stop 205A. And, likewise, upon imparting sliding relative movement between the second solar module frame 201B and the rail body 250, the second locking flange 203 of the second solar module frame 201B can be brought into contact with the second tab 261 after the second locking flange 203 has at least begun to slide by the alignment tab 270. For instance, the second frame 201B can be placed initially at the second channel 204B through the second channel open end 255 and then slid along the second channel 204B at and along the rail body 250 to cause the second locking flange 203 to move from the second channel open end 254 to interface with the second channel hard stop 205B.

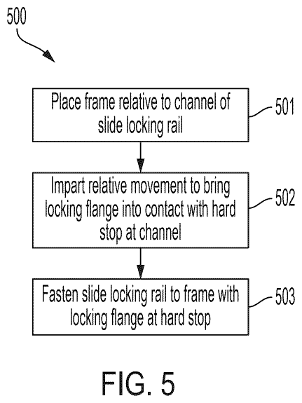

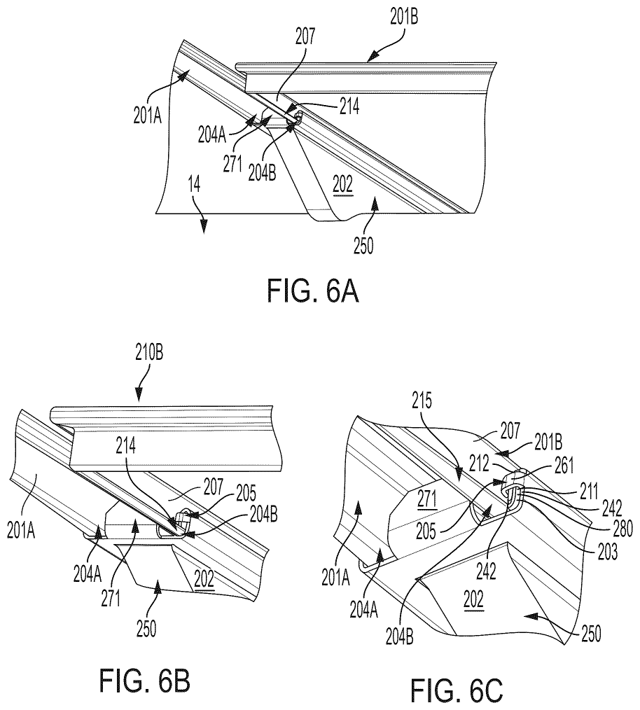

FIG. 5 is a flow diagram of an embodiment of a method 500 for coupling a solar module frame to a slide locking rail. For some embodiments, the method 500 can be executed using one or more of the features disclosed previously herein with respect to the solar module frame 201 and/or with respect to the slide locking rail 202. FIGS. 6A-6C illustrate an exemplary sequence for coupling at least one solar module frame 201 to slide locking rail 202, for instance, such as when executing the method 500. Accordingly, the sequence shown at FIGS. 6A-6C will be discussed as follows in reference to the method 500 to illustrate exemplary features that can be associated with the method 500. More particularly, FIGS. 6A and 6B illustrate an example of placing solar module frame 201B relative to at channel 204B at a slide locking rail 202 and then imparting relative movement between the solar module frame 201B and the channel 204B of the slide locking rail 202. FIG. 6C illustrates an example of bringing locking flange 203 at the solar module frame 201B into contact with hard stop 205 at the channel 204B, after the placing and imparting of relative movement at FIGS. 6A and 6B, such that the slide locking rail 202 can be fastened to the solar module frame 201B with the locking flange 203 of the solar module frame 201B at the hard stop 205, such as shown at the example of FIG. 6C.

As disclosed previously herein, and shown in part again at FIGS. 6A-6C, the locking flange 203 can be at the side 207 of the solar module frame 201B, and this locking flange 203 can include the first locking flange wall 211 and the second locking flange wall 212 (as seen at the examples at FIG. 6C and FIG. 3A). This locking flange 203 can be U-shaped as defined by the walls 211, 212, and the locking flange 203 can extend along a portion of a length of the side 207 of the solar module frame 201B at a generally central region along the length of the side 205 of the solar module frame 201B. The hard stop 205 at the channel 204B can include the tab 261 that extends transversely across the channel 204B at the end 249B of the channel 240B. The end 248B of the channel 204B opposite the end 249B of the channel 240B can include open channel end 255, and the channel 204B can extend along a first side 253 of the slide locking rail 202 between the tab 271 at the end 249B and the open channel end 255 at the opposite end of the channel 204B.

At step 501, the method 500 includes placing solar module frame 201B relative to channel 204B of the slide locking rail 202. For example, referring to FIG. 6A, the end 248B of the channel 204B can include alignment tab 270. At step 501, placing the solar module frame 201B relative to the channel 204B of the slide locking rail 202 can include placing the solar module frame 201B at a side of the alignment tab 270 at or adjacent to the open channel end 255 at the end 248B of the channel 204B. This can cause the solar module frame 201B to land the channel alignment flange 214 and/or the transition flange 215 at a side of the alignment tab 270 at or adjacent to the open channel end 255 at the end 248B of the channel 204B, with the locking flange 203 of the frame 201B offset and spaced apart from the channel 204B (e.g., with the locking flange 203 away from the sidewall 242 that can define a beginning of the channel 204B at the end 248B).

At step 502, the method 500 includes imparting relative movement between the solar module frame 201B and the channel 204B of the slide locking rail 202 until locking flange 203 at the solar module frame 201B is brought into contact with hard stop 205 at the channel 204B. For example, referring to the sequence illustrated by the relative movement between the frame 201B and slide locking rail 202 shown at FIGS. 6B and 6C, imparting relative movement between the solar module frame 201B and the channel 204B of the slide locking rail 202 can include sliding the solar module frame 201B along the channel 204B until the locking flange 203 at the solar module frame 201B is brought into contact with the hard stop 205 within the channel 204B. In one particular such example, for instance, imparting relative movement between the solar module frame 201B and the channel 204B can include sliding the solar module frame 201B from the open channel end 255, along and within the channel 204B, and to the hard stop 205 so as to bring the locking flange 203 at the solar module frame 201B into contact with the tab 261 at the 249B end of the channel 204B. For embodiments where the solar module frame 201B is placed, at step 501, at the slide locking rail 202 such the channel alignment flange 214 and/or the transition flange 215 are at open channel end 255 at the end 248B of the channel 204B, with the locking flange 203 of the frame 201B offset and spaced apart from the channel 204B, imparting relative movement between the solar module frame 201B and the channel 204B at step 502 can include first sliding the channel alignment flange 214 past the tab 261 such that the channel alignment flange passes under the tab 261 and then bringing the locking flange 203 into contact with the tab 261. This can be facilitated via the relatively lesser height 216 of the channel alignment flange 214 being able to pass under the tab 261 but the relatively greater height 217 of the locking flange 203 contacting the structurally interfering tab 261 which can act to stop further sliding movement between the frame 201B and the rail body 250. For instance, where the first and second channels 204A and 204B extend along a length of the rail body in the previously noted east-west orientation, sliding the solar module frame 201B along the channel 204B until the locking flange 203 at the solar module frame 201B is brought into contact with the hard stop 205 within the channel 204B can include sliding the solar module frame 201B along the rail body 250 at the channel 204B in one of an east and west direction.

At step 503, when the locking flange 203 of the solar module frame 201B is in contact with the hard stop 205 at the channel 204B, the method 500 includes fastening the slide locking rail 202 to the solar module frame 201B. For example, referring to the example show at FIG. 6C, the locking flange 203 is shown to have been brought from its location offset from the hard stop 205 at FIGS. 6A and 6B to its location interfacing with (e.g., contacting) the hard stop 205. With the locking flange 203 brought to interface with the hard stop 205 (e.g., with the locking flange 203 brought into contact with the tab 261), the locking flange 203 can be fastened to the channel 204B at the slide locking rail 202 to couple the solar module frame 201B to the slide locking rail 202. For example, the locking flange 203 can be fastened to the channel 204B by fastening the locking flange 203 to the sidewall 242 that defines, at least in part, the channel 204B. For instance, in some cases, the locking flange 203 can be fastened to the sidewall 242 at each of two opposite vertical sides of the locking flange 203 positioned within the channel 204B. As one such example, as shown at FIG. 6C, a fastening member 280 can be inserted through the sidewall 242 and locking flange 203 to fastening the slide locking rail 202 to the solar module frame 201B at the channel 204B (e.g., the fastening member 280 extends from sidewall 242 at one vertical side of the locking flange 203, through the locking flange 203, and to sidewall 242 at another, opposite vertical side of the locking flange 203). As other examples, the slide locking rail 202 can be fastened to the frame 201B using any one or more of a clinch joint, self-tapping screw, self-piercing rivet, blind rivet, and/or clamp component, between the locking flange 203 and the sidewall 242 (e.g., at or adjacent to the channel end 249B). In some additional or alternative examples, the slide locking rail 202 can be fastened to the frame 201B using complementary fastening features included at the structure of the each of the slide locking rail 202 and the frame 201B (e.g., a tab at one or the slide locking rail 202 and the frame 201B and a complementary engageable slot at the other of the slide locking rail 202 and the frame 201B).

Various examples have been described. These and other examples are within the scope of this disclosure and claims pursed from this disclosure.

What is claimed is:

1. A method comprising the steps of:
placing a solar module frame relative to a first channel of a slide locking rail;
imparting relative movement between the solar module frame and the first channel of the slide locking rail until a locking flange at the solar module frame is brought into contact with a hard stop at the first channel; and
when the locking flange at the solar module frame is in contact with the hard stop at the first channel, fastening the slide locking rail to the solar module frame.

2. The method of claim 1, wherein imparting relative movement between the solar module frame and the first channel of the slide locking rail comprises sliding the solar module frame along the first channel until the locking flange at the solar module frame is brought into contact with the hard stop within the first channel.

3. The method of claim 2, wherein the locking flange is at a first side of the solar module frame, and wherein the locking flange comprises a first locking flange wall and a second locking flange wall, the first locking flange wall extending up from the first side of the solar module frame, the second locking flange wall extending down from the first locking flange wall toward the first side of the solar module frame.

4. The method of claim 3, wherein the locking flange is U-shaped and extends along a portion of a length of the first side of the solar module frame at a central region along the length of the first side of the solar module frame.

5. The method of claim 2, wherein the hard stop at the first channel comprises a tab extending transversely across the first channel at a first end of the channel.

6. The method of claim 5, wherein a second end of the channel, opposite the first end of the channel, comprises an open channel end, and wherein the first channel extends along a first side of the slide locking rail between the tab at the first end of the channel and the open channel end at the second end of the channel.

7. The method of claim 6, wherein imparting relative movement between the solar module frame and the first channel of the slide locking rail comprises sliding the solar module frame from the open channel end, along and within the first channel, and to the hard stop to bring the locking flange at the solar module frame into contact with the tab at the first end of the channel.

8. The method of claim 6, wherein the second end of the channel comprises a first alignment tab, and wherein placing the solar module frame relative to the first channel of the slide locking rail comprises placing the solar module frame at a first side of the alignment tab at or adjacent to the open channel end at the second end of the channel.

9. The method of claim 8, wherein the locking flange is at a first longitudinal side of the solar module frame, wherein the first longitudinal side of the solar module frame further comprises a channel alignment flange, and wherein imparting relative movement between the solar module frame and the first channel of the slide locking rail comprises first sliding the channel alignment flange past the tab and then bringing the locking flange into contact with the tab.

10. The method of claim 1, wherein the locking flange at the solar module frame is fastened to the first channel at the slide locking rail to couple the solar module frame to the slide locking rail.

11. A slide locking rail for coupling to one or more solar module frames, the slide locking rail comprising:
a rail body;
a first channel extending along a first side of the rail body from an open first channel end at a first end of the first channel to a first channel hard stop at a second, opposite end of the first channel;
a second channel extending along a second side of the rail body, opposite the first side of the rail body, from an open second channel end at a first end of the second channel to a second channel hard stop at a second, opposite end of the second channel; and
an alignment tab at the rail body between the first channel and the second channel,
wherein, upon relative movement between the first solar module frame and the rail body, the first channel is configured to receive a first locking flange of a first solar module frame at the first channel hard stop to couple the first solar module frame to the rail body at the first channel, and wherein, upon relative movement between the second solar module frame and the rail body, the second channel is configured to receive a second locking flange of a second solar module frame at the second channel hard stop to couple the second solar module frame to the rail body at the second channel.

12. The rail of claim 11, wherein the alignment tab is between the first end of the first channel and the first end of the second channel, and wherein the alignment tab tapers in width as is extends out from the rail body between the first end of the first channel and the first end of the second channel.

13. The rail of claim 12, wherein the alignment tab is a first alignment tab, and wherein the slide locking rail further comprises a second alignment tab, wherein the second alignment tab is between the second channel end of the first channel and the second end of the second channel, and wherein the second alignment tab tapers in width as is extends out from the rail body between the second channel end of the first channel and the second channel end of the second channel.

14. The rail of claim 11, wherein the first channel hard stop comprises a first tab extending transversely across the first channel at the second end of the first channel, and wherein the second channel hard stop comprises a second tab extending transversely across the second channel at the second end of the second channel.

15. The rail of claim 14, wherein the first channel comprises a first sidewall at the first side of the rail body forming a first inverted U-shape as the first sidewall extends out from the rail body, and wherein the second channel comprises a second sidewall at the second side of the rail body forming a second inverted U-shaped as the second sidewall extends out from the rail body.

16. The rail of claim 15, wherein the first tab extends transversely across the first inverted U-shape and terminates prior to a second alignment tab that is between the second channel end of the first channel and the second end of the second channel, and wherein the second tab extends transversely across the second inverted U-shape and terminates prior to the second alignment tab that is between the second channel end of the first channel and the second end of the second channel.

17. The rail of claim 16, wherein, upon imparting sliding relative movement between the first solar module frame and the rail body, the first locking flange of the first solar module frame is brought into contact with the first tab after the first locking flange has at least begun to slide by the alignment tab, and wherein, upon imparting sliding relative movement between the second solar module frame and the rail body, the second locking flange of the second solar module frame is brought into contact with the second tab after the second locking flange has at least begun to slide by the alignment tab.

18. A slide locking rail solar module frame coupling system comprising:
a solar module frame comprising a locking flange; and
a slide locking rail configured to couple to the solar module frame, the slide locking rail comprising:
a rail body,
a first sidewall at a first side of the rail body,
an alignment tab at the rail body spaced apart from the first sidewall,
a first channel defined between the first sidewall and the alignment tab along the first side of the rail body, the first channel extending from a first channel open end to a second channel end, and
a first hard stop extending transversely across at least a portion of the first channel at the second channel end,
wherein, upon relative movement between the solar module frame and the rail body, the first channel is configured to receive the locking flange of the solar module frame in contact with the first hard stop at the first channel.

19. The system of claim 18, wherein the first sidewall forms a first inverted U-shape as the first sidewall extends out from the rail body, and wherein the first hard stop extends transversely across at least the first inverted U-shape.

20. The system of claim 19,
wherein the locking flange is at central region along a length of a first side of the solar module frame, and wherein the locking flange comprises a first locking flange wall and a second locking flange wall, the first locking flange wall extending up from the first side of the solar module frame, the second locking flange wall extending down from the first locking flange wall toward the first side of the solar module frame, and
wherein the first side of the solar module frame further comprises a channel alignment flange and a transition flange, the transition flange extending between the locking flange and the channel alignment flange, the channel alignment flange extending out from the first side of the solar module frame a first height that is less than a second height at which the transition flange extends out from the first side of the solar module frame and less than a third height at which the locking flange extends out from the first side of the solar module frame, the second height at which the transition flange extends out from the first side of the solar module frame being less than the third height at which the locking flange extends out from the first side of the solar module frame.
